(19) United States
(12) Patent Application Publication
(10) Pub. No.: US 2011/0185711 A1
(43) Pub. Date: Aug. 4, 2011

(54) TEXTURED PARTICULATE FILTER FOR CATALYTIC APPLICATIONS

(75) Inventors: Damien Philippe Mey, Cavaillon (FR); Daniel Aubert, Carpentras (FR); Patrice Signoret, Carpentras (FR); William Pierre Michel Mustel, Montmorency (FR)

(73) Assignee: SAINT-GOBAIN CENTRE DE RECH. ET D'ETUDES EUROPEEN, Courbevoie (FR)

(21) Appl. No.: 13/054,114

(22) PCT Filed: Jul. 16, 2009
(86) PCT No.: PCT/FR2009/051421

§ 371 Date: Apr. 7, 2011

(30) Foreign Application Priority Data
Jul. 17, 2008 (FR) 0854877

(51) Int. Cl. F01N 3/021; B05D 5/02; B01D 53/38; B32B 3/12

(52) U.S. Cl. 60/311; 427/244; 422/180; 428/116

(57) ABSTRACT

The subject of the invention is a catalytic filter for the treatment of solid particles and gaseous pollutants coming from the combustion gases of an internal combustion engine, comprising a porous matrix forming an assembly of longitudinal channels separated by porous filtering walls based on or consisting of silicon carbide or aluminum titanate in the form of interconnected grains. The filter according to the invention is characterized in that:
said grains and grain boundaries of said porous filtering walls are covered over at least 70% of their surface area with a texturing material, said texturing consisting of irregularities, the sizes of which are between 10 nm and 5 microns; and
a catalytic coating or washcoat at least partially covers said texturing material and optionally, at least partially, the grains of said porous filtering walls.

The present invention relates to the field of porous filtering materials. More particularly, the invention relates to typically honeycomb structures that can be used for filtering solid particles contained in exhaust gases of a diesel or gasoline engine and additionally incorporating a catalytic component enabling, jointly, polluting gases of the NOₓ, carbon monoxide CO or unburnt hydrocarbon HC type to be eliminated.

Filters for the treatment of gases and for eliminating soot particles typically coming from a diesel engine are well known in the prior art. Usually these structures have a honeycomb structure, one of the faces of the structure allowing entry of the exhaust gases to be treated and the other face allowing exit of the treated exhaust gases. The structure comprises, between these entry and exit faces, an assembly of adjacent ducts or channels, usually square in cross section, having mutually parallel axes separated by porous walls. The ducts are closed off at one or the other of their ends so as to define inlet chambers opening onto the entry face and outlet chambers opening onto the exit face. The channels are alternately closed off in such an order that the exhaust gases, in the course of their passage through the honeycomb body, are forced to pass through the sidewalls of the inlet channels before rejoining the outlet channels. In this way, the particulates or soot particles are deposited and accumulate on the porous walls of the filter body.

The filters according to the invention have a matrix of an inorganic, preferably ceramic, material chosen for its capability of constituting a structure with porous walls and for acceptable thermomechanical strength for application as a particulate filter in an automobile exhaust line. Such a material is typically based on silicon carbide (SiC), in particular recrystallized silicon carbide, or based on aluminium titanate.

The increase in porosity and in particular in the mean pore size is in general desirable for applications for the catalytic filtration treatment of gases. This is because such an increase makes it possible to limit the pressure drop resulting from a particulate filter as described above being positioned in an automobile exhaust line. The term “pressure drop” is understood to mean the pressure difference of the gases that exists between the inlet and the outlet of the filter. However, this increase in porosity is limited by the associated reduction in the thermomechanical strength properties of the filter, especially when the latter is subjected to successive soot particulate accumulation phases and regeneration phases, i.e. phases in which the soot particles are eliminated by burning them within the filter. During these regeneration phases, the filter may be brought to mean inlet temperatures of around 600 to 700° C., while local temperatures of more than 1000° C. may be reached. All these hot spots constitute flaws that are capable over the lifetime of the filter of impairing its performance or even of deactivating its catalytic function. With very high degrees of porosity, for example greater than 70%, it has in particular been found of silicon carbide filters that the thermomechanical strength properties are greatly reduced.

This conflict between the pressure drop undergone by a filter and its thermomechanical strength becomes all the more acute if it is desired to combine the particulate filtration function with an additional component for eliminating or treating the polluting gaseous phases contained in the exhaust gases, of the NOₓ, CO or HC type. Although effective catalysts for treating these pollutants are at the present time very well known, their incorporation into particulate filters clearly poses the problem, on the one hand, of their effectiveness when they are present in the pores of the inorganic matrix constituting the filter and, on the other hand, of their additional contribution to the pressure drop associated with the filter incorporated into an exhaust line.

With the aim of improving the efficiency of the catalytic treatment of the gaseous pollutants, the solution currently most studied consists in increasing the amount of catalytic solution deposited per volume of filter, typically by impregnation.

Therefore, to keep the pressure drop at acceptable values for an application in an automobile exhaust line, a necessary trend in these structures is toward the highest porosity. As explained above, such a trend is very rapidly limited as it inevitably causes too great a drop in the thermomechanical properties of the filter for such an application.

Furthermore, other problems arise because of this increase in catalyst loading. The greater thickness of the catalyst layer substantially increases the local hot spot problems already mentioned, especially during the regeneration phases owing to the poor capability of current catalytic compositions to transfer the soot combustion heat to the inorganic matrix.

Finally, the larger thickness of the catalyst coating may lead to a lower catalytic efficiency, as mentioned in US 2007/0049492, paragraph [005], which may result from a poor distribution of the active sites, i.e. sites where the catalyzed reaction takes place, making them less accessible to the gases to be treated. This has an important impact on the light-off temperature of the catalytic reaction and consequently on the activation time of the catalyzed filter, i.e. the time needed for the cold filter to reach a temperature allowing efficient treatment of the pollutants.

In addition, this trend toward a higher loading of catalyst in filters results in evermore concentrated coating suspensions, causing productivity problems, the coating then being deposited in several impregnation cycles. Feasibility problems also arise because of the high viscosity of these suspensions. This is because above a certain viscosity dependent on the chemical nature of the catalyst solution used for the impregnation, it no longer becomes possible with conventional production means to impregnate the porous substrate efficiently.

In addition to the abovementioned difficulties, associated in particular with the increase in pressure drop, the incorporation of a catalytic component into a particulate filter also poses the following problems:
adhesion of the impregnation solution to the porous substrate must be as uniform and homogeneous as possible, but also must allow a large amount of catalytic solution to be fixed. This problem is all the more critical on matrices that take the form of interconnected grains and have a relatively smooth and/or convex surface, especially SiC-based matrices; and
to alleviate the catalyst aging problem, in particular in the sense described in application EP 1 669 580 A1, the catalytic coating deposited in the pores of the walls of the filter must be sufficiently stable over time, that is to say the catalytic activity must remain acceptable over the entire lifetime of the filter, to meet the current and future pollution-control standards.

At the present time, to guarantee acceptable catalytic performance over the entire lifetime of the filter, the solution adopted is to impregnate a larger amount of catalytic solution, and therefore of noble metals, so as to compensate for the loss of catalytic activity over time, as described in application JP 2006/341201. This solution not only results in an increase in the pressure drop, as mentioned above, but also in the cost of the process, because of the necessarily greater use of noble metals. The problem therefore still remains at the present time of how to limit the aging of the catalyst in order to ensure performance stability.

The objective of the present invention is to provide an improved solution to all the abovementioned problems.

More particularly, one of the objects of the present invention is to provide a porous filter suitable for an application as particulate filter in an automobile exhaust line, which is subjected to successive soot accumulation and combustion phases, and having a catalytic component of higher efficiency.

More particularly, for the same porosity, the catalytic filters according to the invention may have a catalytic charge substantially greater than the current filters. According to another possible embodiment, the catalytic filters according to the invention may have better homogeneity, i.e. more uniform distribution of the catalytic charge in the porous matrix.

Such an increase in and/or the better homogeneity of the catalytic charge enable/enables in particular the efficiency of the pollutant gas treatment to be substantially improved without concomitantly increasing the pressure drop caused by the filter.

The invention thus makes it possible in particular to obtain porous structures having acceptable thermomechanical properties for the application and a substantially improved catalytic efficiency over the entire lifetime of the filter.

Another object of the present invention is to obtain catalyzed filters having better aging resistance, within the meaning described above.

Accordingly, the invention relates to a catalytic filter for the treatment of solid particles and gaseous pollutants coming from the combustion gases of an internal combustion engine, comprising a porous matrix forming an assembly of longitudinal channels separated by porous filtering walls based on or consisting of silicon carbide or aluminum titanate in the form of interconnected grains. The filter is characterized in that:
said grains and grain boundaries of said porous filtering walls are covered over at least 70% of their surface area with a texturing material, said texturing consisting of irregularities, the sizes of which are between 10 nm and 5 microns; and
a catalytic coating or washcoat at least partially covers said texturing material and optionally, at least partially, the grains of said porous filtering walls.

The texturing material advantageously covers at least 80% or 90%, or even 95%, of the total surface area of the grains and grain boundaries of the porous filtering walls. This very high coverage and this better distribution between the surface of the grains and that of the grain boundaries helps to improve the catalytic efficiency even more, without thereby prejudicing the pressure drop of the filter. This higher coverage also to a large extent prevents the texturing material from becoming detached from the surface of the filtering walls during the heat cycles accompanying the use of the filter, especially the regeneration cycles.

A tie layer is advantageously formed at the interface between the texturing material and the grains and grain boundaries of the filtering walls.

This tie layer preferably has one or more of the following advantageous characteristics:
the tie layer preferably has a chemical composition different from the composition of the grains and grain boundaries of the filtering walls and from the composition of the texturing material. The tie layer may in particular have a compositional gradient between the composition of the grains and grain boundaries of the filtering walls and the composition of the texturing material;
the tie layer is preferably obtained by an oxidative chemical reaction, especially due to an oxidative heat treatment in an oxidizing atmosphere at a temperature between 900 and 1500° C., especially between 1000 and 1400° C., and even more preferably between 1100 and 1300° C. This oxidative heat treatment will be described in greater detail later on in the text; and
the tie layer preferably comprises at least 25% by weight, especially 50% and even 80% by weight, of silica. It will for example be obtained by an oxidation reaction of the SiC grains, optionally coupled with a chemical reaction with the texturing material.

The existence of this tie layer helps to improve the adhesion between the grains and grain boundaries on the one hand, and the texturing material on the other. It is thus possible to avoid any detachment of the texturing material during the lifetime of the filter. Preferably, the porous walls are formed from interconnected grains so as to provide cavities between them, such that the open porosity is between 30 and 70% and the median pore diameter is between 5 and 40 μm.

The texturing material is generally of inorganic nature. It may be completely or partially crystalline or completely or partially glassy. It is preferably made of a ceramic. Its thermal stability is preferably at least equal to that of alumina, which is generally the main constituent of the catalytic coating.

The texturing material is preferably formed by aluminosilicates. These aluminosilicates may be defined, perfectly crystalline, compounds, but are usually mixtures of various crystalline phases (such as mullite) and glassy, often siliceous, phases. Preferably, the texturing material is composed of or formed from mullite crystallites in a predominantly amorphous siliceous phase. Mullite has the advantage of having a thermal expansion coefficient close to that of silicon carbide.

The irregularities may be formed by crystallites or clusters of crystallites of a fired or sintered material on the surface of the grains and grain boundaries of the porous walls.

The irregularities may for example be formed essentially by beads of an oxide such as alumina, silica, magnesia or iron oxide.

The irregularities may also take the form of craters hollowed out in a material such as silica or alumina, said material being fired or sintered on the surface of the grains of the porous matrix.

The irregularities forming the texturing preferably have one or more of the following advantageous characteristics:
the irregularities form of rods or acicular or globular structures, hollows or craters, said irregularities preferably having a mean equivalent diameter d of between about 10 nm and about 5 microns, especially between 100 nm and 2.5 microns, and/or a mean height h or mean depth p of between about 10 nm and about 5 microns, especially between 100 nm and 2.5 microns;
the mean equivalent diameter d and/or the mean height h or the mean depth p of the irregularities are/is preferably smaller than the mean size of the grains of the inorganic material constituting the matrix by a factor of between ½ and 1/1000, especially between ⅕ and 1/100; and
the irregularities preferably have a size
   (equivalent diameter, height or depth) distribution such that at least 80% of the sizes are greater than or equal to half the median size and less than or equal to twice this median size. This texture homogeneity is noteworthy and results in the formation of a more homogeneous catalytic coating and consequently a higher catalytic activity.

The term “mean diameter d” is understood within the meaning of the present description to be the mean diameter of the irregularities, these being individually defined from the tangential plane to the surface of the grain or grain boundary on which they are located. The term “mean height h” is understood within the meaning of the present description to be the mean distance between the top of the relief formed by the texturing and the aforementioned plane. The term “mean depth p” is understood within the meaning of the present description to be the mean distance between, on the one hand, the deepest point formed by the impression, for example the hollow or crater of the texturing, and, on the other hand, the aforementioned plane.

Another subject of the invention is processes especially designed to obtain the filter according to the invention.

According to a first method of implementation, the process comprises the following steps:
preparation of a paste comprising ceramic grains and powders;
forming of the paste, followed by drying and firing;
deposition on the surface of at least part of the grains and grain boundaries of the porous filtering walls of a texturing material or at least one of its precursors;
oxidative heat treatment in an oxidizing atmosphere, especially air, at a temperature of between 1100 and 1500° C.; and
impregnation of the textured honeycomb structure with a solution comprising a catalyst or a precursor of a catalyst for the treatment of the gaseous polluting species.

The texturing material may especially be deposited by applying a suspension of said texturing material or one of its precursors on the surface of the grains and grain boundaries, which may or may not be followed by a firing or sintering heat treatment. The suspension may be a slip comprising a powder or powder blend in a liquid such as water. The powders are generally of inorganic nature, preferably ceramic. They preferably comprise silicon oxides and aluminum oxides and may for example be alumina silicates, especially aluminosilicates, whether synthetic or natural, such as andalousite (for example of the kerphalite or purusite type), cyanite (whether calcined or not) or possibly sillimanite, or else a mixture of these various minerals.

The texturing material may also be deposited by applying a sol or a gel (sol-gel solution) comprising especially a filler in the form of inorganic particles, followed by a calcination heat treatment, or else by applying a sol or a gel (sol-gel solution) comprising a filler in the form of organic beads or particles, followed by a calcination heat treatment.

The sol-gel solution may for example be a silica and/or alumina sol, preferably an alumina sol. The sol, especially alumina sol, may comprise fillers in the form of oxide particles, such as iron oxide or magnesium oxide, or alumina silicates. The alumina silicate may especially be a synthetic or natural aluminosilicate, such as an andalousite (for example of the kerphalite or purusite type), a cyanite (whether calcined or not), or possibly a sillimanite or a mixture of these various minerals.

The suspension, sol or gel may furthermore contain additives chosen from: at least one dispersant (for example an acrylic resin or an amine derivative); at least one binder of organic nature (for example an acrylic resin or a cellulose derivative) or even of mineral nature (clay); at least one wetting or film-forming agent (for example a polyvinyl alcohol PVA); at least one pore former (for example polymers, such as a latex or polymethyl methacrylate), some of these additives possibly combining several of these functions. Just like the form and the particle size of the powders or precursors and the nature of the suspension liquid, the nature and the amount of these additives will have an impact on the size of the microtexturing and its location on the grains and grain boundaries.

The oxidative heat treatment is preferably carried out at a temperature of between 1100 and 1400° C., especially between 1100° C. and 1300° C.

This oxidative heat treatment makes it possible for the surface area covered by the texturing material and the homogeneity of the latter to be considerably increased. Furthermore, it advantageously enables a tie layer to be formed at the interface between the grains and grain boundaries of the filtering walls and the texturing material. The textured surface obtained has large irregularities over most of the surface of the grains and grain boundaries. The catalytic activity of the filter is thus improved, as is the adhesion between the filtering walls and the texturing material.

Too low an oxidative heat treatment temperature results in an insufficient coverage by the texturing material. However, at too high a temperature, a crystalline silica phase, especially cristobalite, may appear, reducing the thermal shock resistance of the filter. The oxidative heat treatment generally comprises a temperature rise followed by a temperature hold, at the actual treatment temperature. The duration of the temperature hold is preferably between 0.5 and 10 hours. The rate of temperature rise before reaching the treatment temperature is typically between 20 and 500° C./hour.

According to a second method of implementation, the process comprises the following steps:
preparation of a paste comprising ceramic grains and powders and at least one precursor of a texturing material;
forming of the paste, followed by drying and firing;
heat treatment in an oxidizing atmosphere, especially air, at a temperature of between 900 and 1500° C.; and
impregnation of the textured honeycomb structure with a solution comprising a catalyst or a precursor of a catalyst for the treatment of the gaseous polluting species.

The paste is generally obtained in a known manner by mixing water with a blend of ceramic powders, especially silicon carbide. After mixing, the paste is formed by extrusion. The firing, generally carried out at over 2000° C. in an inert atmosphere (in the case of silicon carbide), results in the filter.

Preferably, the precursor of a texturing material comprises aluminum and/or silicon in metal, oxide, nitride or oxynitride form, or any one of their mixtures, solid solutions or alloys. For example, mention may be made of silicon aluminum oxynitrides of the SiAlON type or SiAl metal alloys. It may also be alumina, optionally hydrated, or aluminum nitride.

The precursor of the texturing material may also be an alumina silicate, whether synthetic or natural, such as andalousite (especially of the kerphalite or purusite type), cyanite (whether calcined or not) or possibly sillimanite or a mixture comprising these various minerals.

The precursor of the texturing material preferably has a median diameter of between 0.01 and 5 microns, especially between 0.05 and 3 microns.

The firing, when it is carried out in an inert atmosphere at very high temperature, generally above 2000° C., as in the case of silicon carbide, does not reveal the presence of the precursor and generates no texturing. The latter is revealed only after the oxidative treatment, by the creation of the texturing material. It would seem that the oxidizing treatment has the effect of making the precursor migrate to the surface of the grains and grain boundaries, where it reacts chemically with the latter to form a very characteristic texturing material.

The oxidative heat treatment is preferably carried out at a temperature of between 1000 and 1400° C., especially between 1100° C. and 1300° C.

The oxidative heat treatment is generally carried out in a separate step from the firing. This is in particular the case for silicon carbide filters, for which the firing must be carried out in an inert atmosphere. However, it is possible to carry out the oxidative heat treatment as the temperature drops after the firing. Alternatively, the oxidative heat treatment may be carried out during the firing. This may be the case for aluminum titanate filters, which are generally fired in an oxidizing atmosphere, within the temperature range of the treatment according to the invention.

The oxidative heat treatment makes it possible to form a texturing material covering most of the surface of the grains and grain boundaries. Advantageously the heat treatment makes it possible to create a tie layer as defined above. The textured surface obtained by this treatment has large irregularities over most of the surface of the grains and grain boundaries. The catalytic activity of the filter is thus improved, as is the adhesion between the filtering walls and the texturing material.

Too low an oxidative heat treatment temperature results in an insufficient coverage by the texturing material. However, at too high a temperature, a crystalline silica phase, especially cristobalite, may appear, reducing the thermal shock resistance of the filter. The oxidative heat treatment generally comprises a temperature rise followed by a temperature hold, at the actual treatment temperature. The duration of the temperature hold is preferably between 0.5 and 10 hours. The rate of temperature rise before reaching the treatment temperature is typically between 20 and 500° C./hour.

The points in common between the two methods of implementation of the process according to the invention are therefore, on the one hand, the introduction of a texturing material or one of its precursors (after the forming and firing of the filter in the first method of implementation, or before the forming and firing in the second method of implementation) and, on the other hand, a final oxidative treatment between 900 and 1500° C. or between 1100 and 1500° C. after firing. This oxidative treatment makes it possible, as indicated above, to very substantially increase the coverage of the grains and grain boundaries with the texturing material and generally makes it possible to create a tie layer, this being particularly advantageous in terms of adhesion of the texturing material. It is also apparent that the oxidative treatment after the texturing material has been deposited or after addition of a precursor of this material enables the mechanical strength of the filter, in particular its flexural strength, to be quite considerably increased. The partial pressure of the oxidizing gas during the oxidative heat treatment may be adapted so as to result in a passive or active oxidation.

Within the meaning of the present invention, the term “catalytic coating” is defined as a coating comprising an inorganic support material of high specific surface area (typically of the order of 10 to 100 m²/g) for dispersing and stabilizing an active phase, such as metals, generally noble metals, acting as actual catalysis center for the oxidation or reduction reactions. The active phase may catalyze the conversion of the gaseous pollutants, i.e. mainly carbon monoxide (CO) and unburnt hydrocarbons and nitrogen oxides (NOₓ), into less harmful gases such as gaseous nitrogen (N₂) or carbon dioxide (CO₂) and/or facilitate the combustion of the soot particles stored on the filter. The catalyst therefore comprises at least one support material and at least one active phase.

The support material is typically based on oxides, more particularly on alumina or silica, or on other oxides, for example based on ceria, zirconia or titania, or even mixed blends of these various oxides. The size of the particles of support material constituting the catalytic coating on which the catalytic metal particles are placed is of the order of a few nanometers to a few tens of nanometers, or exceptionally a few hundred nanometers.

The catalytic coating is typically obtained by impregnation with a solution comprising the catalyst, in the form of the support material or its precursors and of an active phase or a precursor of the active phase. In general, the precursors used take the form of organic or mineral salts or compounds, dissolved or in suspension in an aqueous or organic solution. The impregnation is followed by a heat treatment for the purpose of obtaining the final coating of a solid and catalytically active phase in the pores of the filter.

Such processes, and the devices for implementing them, are for example described in the patent applications or patents US 2003/044520, WO 2004/091786, U.S. Pat. No. 6,149,973, U.S. Pat. No. 6,627,257, U.S. Pat. No. 6,478,874, U.S. Pat. No. 5,866,210, U.S. Pat. No. 4,609,563, U.S. Pat. No. 4,550,034, U.S. Pat. No. 6,599,570, U.S. Pat. No. 4,208,454 or U.S. Pat. No. 5,422,138.

Whatever the method used, the cost of the catalysts deposited, which usually contain precious metals of the platinum group (Pt, Pd, Rh) as active phase on an oxide support, represents a not inconsiderable part of the overall cost of the impregnation process. For the sake of economy, it is therefore important for the catalyst to be deposited as uniformly as possible, so as to be easily accessible by the gaseous reactants.

The final subject of the invention is an intermediate structure for obtaining a catalytic filter according to the invention. This intermediate structure corresponds to the filter before any deposition of a catalytic coating. The intermediate structure according to the invention comprises a porous matrix based on or consisting of silicon carbide or aluminum titanate, in the form of interconnected grains, said grains and grain boundaries being covered over at least 70% of their surface area with a texturing material as defined above.

Preferably, a tie layer is formed at the interface between the texturing material and the grains and grain boundaries of the filtering walls. The preferred characteristics of the tie layer have been explained above.

The invention and its advantages will be better understood on reading the following exemplary embodiments, which do not limit the present invention and are provided exclusively as illustration.

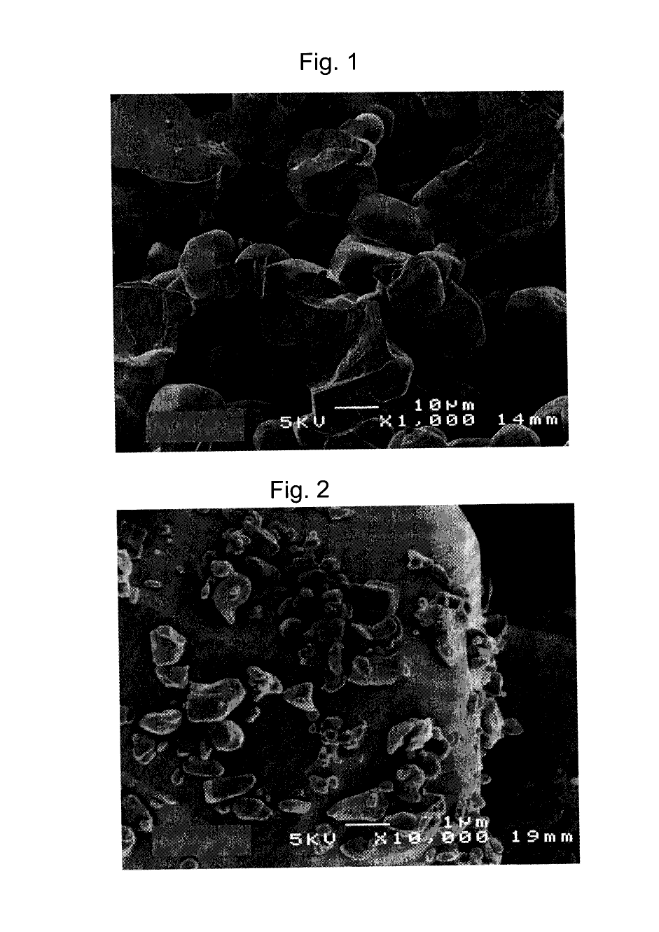

FIGS. 1 to 6 are micrographs taken using a scanning electron microscope (SEM) of the filtering walls of the following examples.

### COMPARATIVE EXAMPLE C1

In this example, an SiC-based catalytic filter was synthesized in the manner normally used.

Firstly, 70% by weight of an SiC powder having grains with a median diameter d₅₀ of 10 microns was blended with a second SiC powder having grains with a median diameter d₅₀ of 0.5 microns, in a first embodiment comparable to the powder blend described in application EP 1 142 619. Within the context of the present description, the term “median pore diameter d₅₀” denotes the diameter of the particles such that respectively 50% of the total population of the grains has a size smaller than or equal to this diameter. Added to this blend was a pore former of the polyethylene type in a proportion equal to 5% by weight of the total weight of the SiC grains and a forming additive of the methylcellulose type in a proportion equal to 10% by weight of the total weight of the SiC grains.

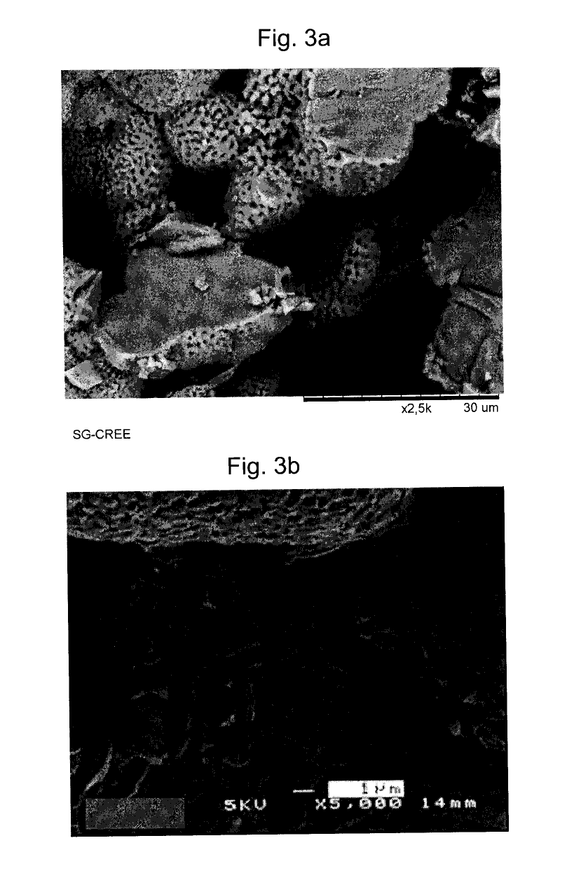

Next, the necessary amount of water was added and mixing was carried out until a homogeneous paste was obtained that had a plasticity enabling it to be extruded through a die having a honeycomb structure so as to produce monoliths characterized by a wavy arrangement of the internal channels such as those described in relation to FIG. 3 of application WO 05/016491. In cross section, the waviness of the walls is characterized by an asymmetry factor, as defined in application WO 05/016491, equal to 7%.

The dimensional characteristics of the structure after extrusion are given in Table 1:

TABLE 1

| Channel geometry | wavy | |
|---|---|---|
| Channel density | 27.9 | channels/cm² |
| Internal wall thickness | 300 | μm |
| Mean external wall thickness | 600 | μm |
| Length | 17.4 | cm |
| Width | 3.6 | cm |

Next, the green monoliths obtained were dried by microwave drying for a time sufficient to bring the content of water not chemically bound to less than 1% by weight.

The channels of each face of the monoliths were alternately plugged using well-known techniques, for example those described in application WO 2004/065088.

The monoliths were then fired in argon with a temperature rise of 20° C./hour until a maximum temperature of 2200° C. was reached, this being maintained for 6 hours.

Thus, an uncoated SiC filtering structure was obtained. As can be seen FIG. 1, the filtering walls of the filter are formed by a matrix of SiC grains of smooth surface interconnected by grain boundaries, the porosity of the material being provided by the cavities left between the grains.

### COMPARATIVE EXAMPLE C2

In this example, the uncoated structure obtained according to example C1 was then subjected to a first texturing treatment, the material used for the texturing being introduced into the pores of the filter in the form of an SiC-based slip.

The slip comprised, in percentages by weight, 96% of water, 0.1% of dispersant of the nonionic type, 1.0% of a binder of the PVA (polyvinyl alcohol) type and 2.8% of an SiC powder with a median diameter of 0.5 μm, the purity of which was greater than 98% by weight.

The slip was prepared according to the following steps:

The PVA, used as binder, was firstly dissolved in water heated to 80° C. The dispersant and then the SiC powder were introduced into a tank containing the PVA dissolved in water and kept stirred until a homogeneous suspension was obtained.

The slip was deposited into the filter by simple immersion, the excess suspension being removed by vacuum suction under a residual pressure of 10 mbar.

The monoliths thus obtained underwent a drying step at 120° C. for 16 hours followed by a sintering heat treatment at 1700° C. in argon for 3 hours. This treatment in an inert atmosphere does not make it possible, unlike the treatment according to the invention, to obtain a high coverage of the surface of the grains and grain boundaries and to form a tie layer.

FIG. 2 shows an SEM micrograph of the filtering walls of the textured filter thus obtained, showing the irregularities on the surface of the SiC grains constituting the porous matrix. In this example the irregularities take the form of SiC crystallites and SiC crystallite clusters. The area covered by the texturing material is relatively very small.

According to this embodiment, the measured parameter d corresponds to the mean diameter, as described above, of the crystallites present on the surface of the SiC grains. The parameter h corresponds to the mean height h of said crystallites.

### EXAMPLE 3 (ACCORDING TO THE INVENTION) AND EXAMPLE C3 (COMPARATIVE EXAMPLE)

In this example, the uncoated structure obtained according to example C1 was subjected to another texturing treatment. The texturing material was introduced into the pores of the filter in the form of an alumina sol sold by the company Sasol under the reference Disperal®. This sol, having a pH of around 2, comprises 5% by weight of boehmite in an aqueous nitric acid solution.

The monolith was impregnated with the alumina sol by simple immersion, the excess being removed by applying a vacuum, under a residual pressure of 10 mbar. The monolith was then subjected to a calcination heat treatment at 500° C. in air for 2 hours followed by an oxidative heat treatment in air at 1200° C. for 4 hours in order to make the alumina coating react with the SiC substrate.

FIGS. 3 a and b show that the texturing is obtained in the form of acicular or globular structures. These irregularities are composed of aluminosilicate, particularly mullite, crystallites in a predominantly amorphous siliceous phase: this demonstrates the chemical reaction between the deposited alumina and the silica resulting from the oxidation of the substrate. Formed between these irregularities and the grains was a thin layer very rich in silica resulting from the oxidation of the grains and grain boundaries as FIGS. 3 a and b show.

As described above, the irregularities have at the surface of the grains a mean height h of 0.7 μm and a mean diameter d of 2.0 μm, which correspond to the diameter and to the length of the rods, respectively, which are observed in FIG. 3b. The irregularities also have a mean depth p of 0.7 μm.

The irregularities cover almost all of the surface of the grains and grain boundaries. It may be estimated that the degree of coverage of the surface with the texturing material is more than 95%.

Comparative example C3 differs from example 3 only in that it did not undergo the oxidative heat treatment in air at 1200° C.

### EXAMPLE 4 (ACCORDING TO THE INVENTION) AND EXAMPLE C4 (COMPARATIVE EXAMPLE)

Unlike the previous example, the uncoated structure obtained according to example 1 was impregnated with an alumina sol filled with magnesia (MgO) in an amount of 5% by weight relative to the amount of alumina and with iron oxide (Fe₂O₃) in an amount of 5% by weight relative to the amount of alumina. The magnesia was supplied in hydrate form. The iron oxide was supplied in powder form as sold under the name CRM 50 by Rana Gruber. The purity of the iron oxide was around 97% and the median diameter was around 0.6 microns.

The monolith thus obtained underwent the same oxidative heat treatment as that according to example 3.

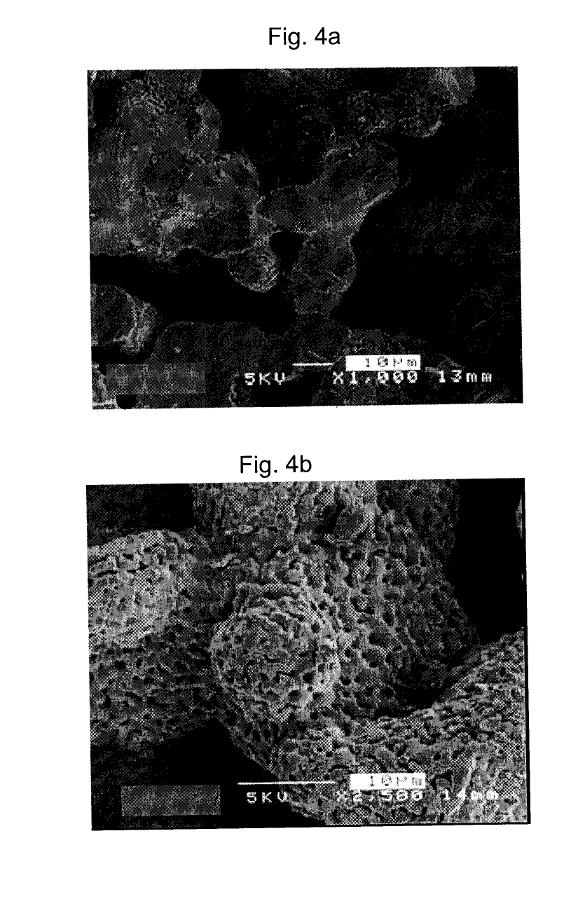

FIGS. 4a and b show that the texturing obtained is in the form of globular and acicular structures. These irregularities are composed of aluminosilicate crystallites in a predominantly amorphous siliceous phase. Formed between these irregularities and the grains was a thin layer very rich in silica resulting from the oxidation of the grains and the grain boundaries.

These irregularities are formed by globular excrescences having a mean height h=1.9 atm and a mean equivalent diameter d=1.9 μm. These excrescences are separated by hollows, the mean depth p of which is 1.5 μm.

Comparative example C4 differs from example 4 only in that it did not undergo the oxidative heat treatment in air at 1200° C.

### EXAMPLE 5 (ACCORDING TO THE INVENTION) AND EXAMPLE C5 (COMPARATIVE EXAMPLE)

In this example, the uncoated structure was obtained according to example C1 except that a precursor of the texturing material was added to the SiC powder blend.

The precursor of the texturing material was reactive alumina in the form of a powder with a median diameter of about 0.8 μm, sold under the reference CT3000SG by Almatis. The content added was 2% by weight relative to the amount of silicon carbide powders.

The amount of mixing water was adapted so as to obtain a homogeneous and plastic paste. Monoliths were then obtained by extrusion, after which they were dried, plugged and fired in a manner similar to example C1.

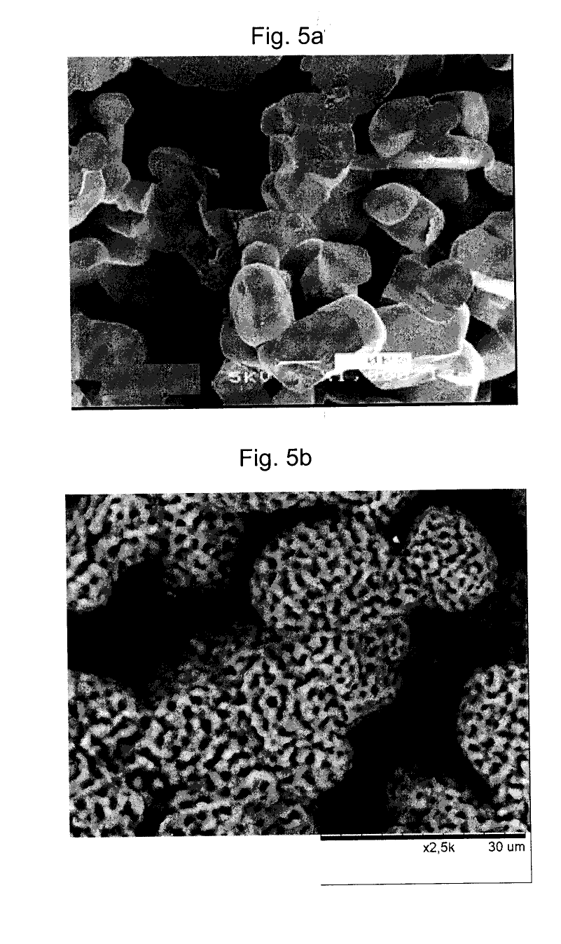

These products were observed under a scanning microscope. As FIG. 5a shows, the microstructure before the oxidative treatment is very similar to that of the reference product according to example C1. No texturing is observed.

The monoliths were then subjected to an oxidative heat treatment at 1200° C. in air for 4 hours.

FIG. 5 b shows that the texturing obtained thanks to this oxidative heat treatment has a globular structure. The irregularities are composed of aluminosilicate, particularly mullite, crystallites in a predominantly amorphous siliceous phase. Formed between these irregularities and the grains is a thin layer very rich in silica resulting from the oxidation of the grains and the grain boundaries.

These irregularities are formed by globular excrescences having a mean height h=0.9 μm and a mean equivalent diameter d=0.9 μm. These excrescences are separated by hollows, the mean depth p of which is 0.9 μm.

Comparative example C5 differs from example 5 only in that it has not undergone the oxidative heat treatment in air at 1200° C. Comparative example C5 is therefore illustrated by FIG. 5a.

### EXAMPLE 6 (ACCORDING TO THE INVENTION) AND EXAMPLE C6 (COMPARATIVE EXAMPLE)

Unlike example 5 above, the precursor of the texturing material was aluminum nitride. 2% of an aluminum nitride (AlN) powder with a mean diameter of 2.5 μm were added to the extrusion mixture instead of alumina powder. The monoliths were obtained using the same process as that described in example 5.

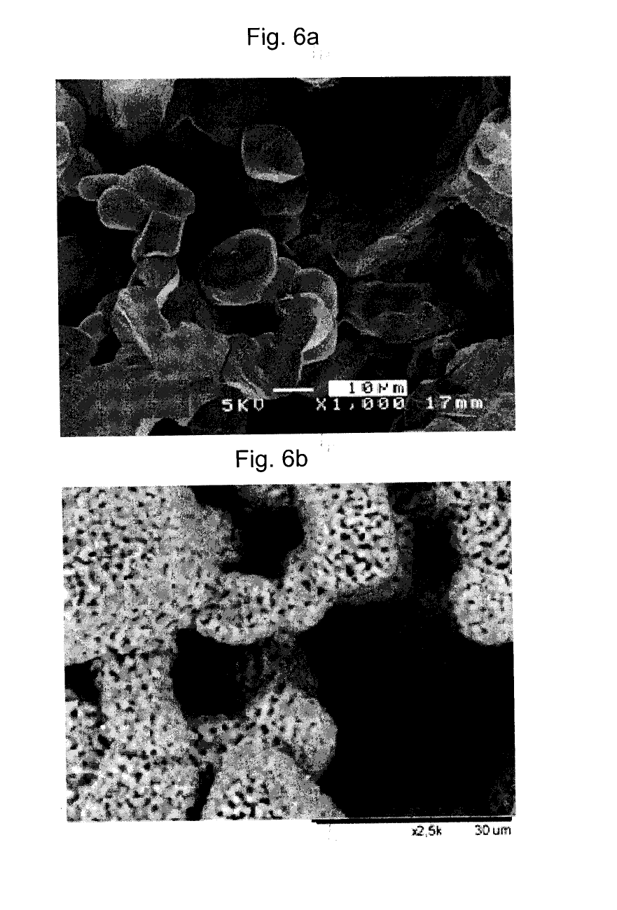

These products were observed in a scanning microscope. As shown in FIG. 6a, the microstructure is very similar to that of the reference product according to example C1. No texturing is apparent from the firing.

The monoliths were then subjected to the same oxidative heat treatment as that described for example 5.

FIG. 6 b shows that the texturing obtained thanks to the oxidative heat treatment has a very characteristic globular structure. These irregularities are composed of about 2% alumina in a siliceous phase. Formed between these irregularities and the grains was a thin layer very rich in silica resulting from the oxidation of the grains and grain boundaries.

These irregularities are formed by globular excrescences with a mean height h=0.9 μm and a mean equivalent diameter d=0.9 μm. These excrescences are separated by hollows, the mean depth p of which is 0.9 μm.

Comparative example C6 differs from example 6 only in that it did not undergo the oxidative heat treatment in air at 1200° C. It is therefore illustrated by FIG. 6a.

The properties of these textured monoliths of examples 3 to 6 according to the invention were measured and compared with those of the comparative examples.

These properties were measured according to the following experimental protocols:

### A: Weight Uptake During the Addition of the Texturing Element or its Precursor:

The weight uptake associated with the deposition of the texturing material or with the addition of its precursor was measured for each monolith before oxidative heat treatment and related to the weight of the reference monolith. This weight uptake corresponds to the amount of texturing agent involved.

### B: Weight Uptake During the Oxidative Heat Treatment

The weight uptake associated with this step enables the reaction of the substrate with the texturing agent or its precursor during the oxidative heat treatment to be quantified.

The associated weight uptake was measured on each monolith after the oxidative heat treatment and related to the weight of the monolith before this heat treatment.

### C: Measurement of the Porosity of the Material Constituting the Matrix and of the Flexural Strength

The open porosity was determined using conventional high-pressure mercury porosimetry techniques using a Micromeritics 9500 porosimeter.

The flexural strength was measured at room temperature according to the ISO 5014 standard, by 3-point bending with a distance of 40 mm between supports and the punch being lowered at a rate of 0.4 mm/min. The specimens were bars fired and extruded at the same time as the monoliths, the dimensions of which are 60*6*8 mm³.

### D: Measurement of the Geometric Characteristics of the Irregularities of the Texturing Coating

The parameters d, h or p as defined above, characterizing the irregularities present on the surface of the grains, were measured by a series of scanning electron microscope observations, on a series of images representative of the coating deposited and at various points on the monolith.

These images, from which FIGS. 1 to 6 are extracted, correspond to characteristic views of the internal structure, in particular of the open porosity, of the walls of channels fractured in the transverse direction, within the monolith.

Other SEM observations, carried out on a series of micrographs at different points on the monolith, also enabled the surface area covered by the texturing material to be measured relative to the total surface area of the grains and grain boundaries of the inorganic material constituting the porous matrix.

E: Measurement of the Quantity of Catalytic Coating (or Washcoat) after Impregnation

The monoliths were subjected to an impregnation treatment with a catalytic solution, according to the following experimental protocol.

The monolith was immersed in a bath of an aqueous solution containing the appropriate proportions of a platinum precursor in the H₂PtCl₆ form, of a cerium oxide (CeO₂) precursor (in the form of cerium nitrate) and of a zirconium oxide (ZrO₂) precursor (in the form of zirconyl nitrate) according to the principles described in the publication EP 1 338 322 A1. The monolith was impregnated with the solution using a method of implementation similar to that described in the U.S. Pat. No. 5,866,210. The loading of impregnation solution given in Table 3 corresponds to the amount of impregnation solution (in grams) divided by the volume of impregnated filter (in liters).

The monolith was then dried at about 150° C. and then heated to a temperature of about 500° C.

### F: Measurement of the Pressure Drop

The pressure drop of the monoliths obtained after the catalytic impregnation described above was measured using the techniques of the art in a stream of ambient air, having an air flow rate of 30 m³/h. The term “pressure drop” is understood within the meaning of the present invention to be the differential pressure existing between the upstream side and the downstream side of the monolith.

### G: Light-Off Catalytic Efficiency Test

This test was intended to measure the light-off temperature of the catalyst. This temperature is defined, under constant gas pressure and flow rate conditions, as the temperature for which a catalyst converts 50% by volume of the pollutant gases. The CO and HC conversion temperature was determined here using an experimental protocol identical to that described in application EP 1759763, especially in paragraphs 33 and 34 thereof. According to the measurement, the lower the conversion temperature, the more efficient the catalytic system.

The test was carried out on specimens measuring about 25 cm³ cut from a monolith.

### H: Post-Aging Light-Off Catalytic Efficiency Test

The monoliths were pre-impregnated with catalyst as described in paragraph E and then placed in a furnace at 800° C. in wet air for a duration of 5 hours. The humidity of the air was such that the molar concentration of water was kept constant at 3%. The degree of CO conversion at 420° C. and the HC light-off temperature were measured on each monolith specimen thus aged, using the same experimental protocol as that described in point G above. The increase in HC light-off temperature was calculated from the difference between the HC light-off temperature on an aged specimen and that measured on an unaged specimen. According to these tests, the lower the light-off temperature on an aged specimen or the smaller the increase in light-off temperature due to aging, the greater the aging resistance of the catalytic system. The higher the post-aging degree of conversion, the more efficient the catalytic system.

Table 2 shows the results in terms of flexural strength.

Table 3 gives the main measured characteristics according to the tests described above.

TABLE 2

| | Example | | | | |
|---|---|---|---|---|---|
| | C1 | C5 | 5 | C6 | 6 |
| Flexural strength (MPa) | 25 | 39 | 70 | 41 | 75 |

TABLE 3

| | | Example | | | | | | | |
|---|---|---|---|---|---|---|---|---|---|
| | | C1 | C2 | 3 | C3 | 4 | C4 | 5 | 6 |
| A: Texturing material (wt %) | | 0 | 3.4 | 1.0 | 1.0 | 0.8 | 0.8 | 2 | 2 |
| B: Weight uptake (%) | | — | — | 3 | — | 3 | — | 1.7 | 1.4 |
| after oxidative heat treatment | | | | | | | | | |
| C: Porosity (%) | | 48 | 47 | 45 | | 45 | | 46 | 47 |
| Flexural strength | | 25 | | | | | | 70 | 75 |
| (MPa) | | | | | | | | | |
| D: | p (μm) | — | — | 0.7 | | 1.5 | | 0.9 | 0.9 |
| | h (μm) | — | 0.5 | 0.7 | | 1.9 | | 0.9 | 0.9 |
| | d (μm) | — | 0.5 | 2.0 | | 1.9 | | 0.9 | 0.9 |

| | | | | | | | | |
|---|---|---|---|---|---|---|---|---|
| Area covered (%) | — | 18 | >95 | | >95 | | >95 | >95 |
| E: Amount of washcoat | 185 | 200 | 205 | 200 | 204 | 201 | 205 | 200 |
| deposited on the | | | | | | | | |
| filter (g/l of filter) | | | | | | | | |
| F: Pressure drop | 21 | 21 | 21 | 22 | 22 | 23 | 21 | 22 |
| (mbar) | | | | | | | | |
| G: Light-off test: | | | | | | | | |
| a) Temperature (° C.) for | 275 | 265 | 240 | 256 | 235 | 257 | 235 | 235 |
| converting 50% of the | | | | | | | | |
| CO of the gas mixture | | | | | | | | |
| b) Temperature (° C.) for | 282 | 275 | 260 | 262 | 260 | 261 | 255 | 265 |
| converting 50% of the | | | | | | | | |
| HC of the gas mixture | | | | | | | | |
| H: Light-off test on | | | | | | | | |
| aged filter: | | | | | | | | |
| a) Degree of conversion | 10 | 16 | 20 | 15 | 25 | 16 | 23 | 23 |
| (in %) of the CO of | | | | | | | | |
| the gas mixture at | | | | | | | | |
| 420° C. | | | | | | | | |
| b) Temperature (° C.) for | 400 | 391 | 385 | 393 | 382 | 395 | 380 | 380 |
| converting 50% of the | | | | | | | | |
| HC of the gas mixture | | | | | | | | |
| c) Increase in the HC | 118 | 116 | 125 | 133 | 122 | 134 | 125 | 115 |
| 50% conversion | | | | | | | | |
| temperature (° C.) | | | | | | | | |

Over 95% of the surface of the filters according to the invention are covered with the texturing material, therefore giving an almost complete coverage, unlike examples C2 to C4, which did not undergo an oxidative heat treatment.

The filters of examples 3, 4 and 5 show a substantially higher level of loading of catalytic coating (washcoat) than that of the comparative examples, for equivalent or even slightly lower porosity characteristics. It should be noted that the pressure drop caused by the filters according to the invention is hardly affected by the significant increase in the amount of catalyst present in the textured filters according to the invention. Thus, the measured pressure drop values remain very acceptable for the filtering application.

All the filters of the invention show a more effective catalytic activity than that of the comparative examples.

For an equal amount of catalytic coatings, example 6 shows a very much greater catalytic efficiency than comparative example C2, which could be interpreted as the result of better distribution of the catalyst or else easier access to the active sites for the gases to be purified.

All the filters of the invention show a higher catalytic performance after aging than that of the comparative examples. In particular, examples 5 and 6 show the best aging resistance values. Likewise, filters 3 and 4 according to the invention exhibit a smaller reduction in catalytic performance after aging than comparative filters C3 and C4.

Furthermore, the filters according to the invention retain all their mechanical strength properties, while still maintaining their filtration efficiency, unlike the solutions known hitherto for increasing the loading of catalyst present in the pores of the filtering structures, especially by increasing the size of the pores (open porosity, pore diameter). In particular, the flexural strength measurements demonstrate that improved strength may be obtained by means of the texturing, this improvement in strength being much greater for the specimens that have also undergone oxidative heat treatment (examples 5 and 6). This advantage may make it possible to further reduce the wall thickness of the filters and to increase the loading of catalyst and/or reduce the pressure drop for equivalent mechanical strength.

1. A catalytic filter, comprising a porous matrix forming an assembly of longitudinal channels separated by porous filtering walls comprising silicon carbide or aluminum titanate in the form of interconnected grains, wherein:
said grains and grain boundaries of said porous filtering walls are covered over at least 70% of their surface area with a texturing material, giving a texturing of irregularities, the sizes of which are between 10 nm and 5 microns;
a catalytic coating or washcoat at least partially covers said texturing material and optionally, at least partially, the grains of said porous filtering walls, and
the catalytic filter is suitable for treating at least one solid particle or gaseous pollutant from a combustion gas of an internal combustion engine.

2. The filter of claim 1, wherein the texturing material covers at least 80% or 90% of a total surface area of the grains and grain boundaries of the porous filtering walls.

3. The filter of claim 2, wherein a tie layer is formed at an interface between the texturing material and the grains and grain boundaries of the filtering walls.

4. The filter of claim 3, wherein the tie layer has a chemical composition different from a composition of the grains and grain boundaries of the filtering walls and from a composition of the texturing material.

5. The filter of claim 3, wherein the tie layer has a compositional gradient between a composition of the grains and grain boundaries of the filtering walls and a composition of the texturing material.

6. The filter of claim 3, wherein the tie layer comprises at least 25% by weight of silica.

7. The filter of claim 1, wherein the irregularities are formed by crystallites or clusters of crystallites of a fired or sintered material on a surface of the grains and grain boundaries of the porous walls, said irregularities having a mean equivalent diameter d of between about 10 nm and about 5 microns, and/or a mean height h or mean depth p of between about 10 nm and about 5 microns.

8. The filter of claim 1, wherein a mean equivalent diameter d and/or a mean height h or a mean depth p of the irregularities are/is smaller than a mean size of the grains of the silicon carbide or aluminum titanate constituting the porous matrix by a factor of between ½ and 1/1000.

9. The filter of claim 1, wherein the texturing material is formed by aluminosilicates.

10. An intermediate structure for obtaining the catalytic filter of claim 1, comprising a porous matrix comprising silicon carbide or aluminum titanate, in the form of interconnected grains,
wherein said grains and grain boundaries are covered over at least 70% of their surface area with a texturing material, giving a texture of irregularities with sizes between 10 nm and 5 microns.

11. A process for obtaining the filter of claim 1, or an intermediate structure comprising a porous matrix comprising silicon carbide or aluminum titanate, in the form of interconnected grains,
wherein said grains and grain boundaries are covered over at least 70% of their surface area with a texturing material, giving a texture of irregularities with sizes between 10 nm and 5 microns, the process comprising:
(A) preparing a paste comprising ceramic grains and powders;
(B) forming of the paste, giving a formed paste, followed by drying and firing the formed paste, to give a first precursor;
(C) depositing, on a surface of at least part of the grains and grain boundaries of porous filtering walls of the first precursor, a texturing material or at least one precursor of the texturing material, to give a second precursor;
(D) oxidatively heat treating the second precursor in an oxidizing atmosphere, at a temperature of between 1100° C. and 1500° C., to give a third precursor; and
(E) optionally, impregnating a textured honeycomb structure of the third precursor with a solution comprising a catalyst or a precursor of a catalyst for the treatment of the gaseous polluting species.

12. The process of claim 11, wherein the depositing (C) comprises applying a suspension of said texturing material or one of its precursors on the surface of the grains and grain boundaries.

13. The process of claim 11, wherein the depositing (C) comprises applying a sol-gel solution comprising a filler in the form of inorganic particles to the grains or grain boundaries, followed by a calcination heat treatment.

14. The process of claim 13, wherein the sol-gel solution is a silica and/or alumina sol.

15. A process for obtaining the filter of claim 1 as or an intermediate structure comprising a porous matrix comprising silicon carbide or aluminum titanate, in the form of interconnected grains,
wherein said grains and grain boundaries are covered over at least 70% of their surface area with a texturing material, giving a texture of irregularities with sizes between 10 nm and 5 microns, the process comprising:
(A) preparing a paste comprising ceramic grains and powders and at least one precursor of a texturing material;
(B) forming of the paste, to give a formed paste, followed by drying and firing the formed paste, to give a fired paste;
(C) oxidatively heat treating the fired paste in an oxidizing atmosphere, at a temperature of between 900 and 1500° C., to give an oxidated paste which has a textured honeycomb structure; and
(D) optionally, impregnating the textured honeycomb structure with a solution comprising a catalyst or a precursor of a catalyst which treats a gaseous polluting species.

16. The process of claim 15, such that the at least one precursor of the texturing material comprises aluminum and/or silicon in metal, oxide, nitride, or oxynitride form, or any one of their mixtures, solid solutions, or alloys.

17. An exhaust line of a diesel or gasoline engine, comprising the filter of claim 1.

18. The filter of claim 3, wherein the tie layer comprises at least 50% by weight of silica.

19. The filter of claim 7, wherein the crystallites or clusters are in the form of rods or acicular or global structures, hollows or craters.

20. The filter of claim 7, wherein the irregulatities have
a mean equivalent diameter d and/or
a mean height h or mean depth p
of between 100 nm and 2.5 microns.
